(19) United States
(12) Patent Application Publication
(10) Pub. No.: US 2004/0125016 A1
(43) Pub. Date: Jul. 1, 2004

(54) Compressed cube antenna in a volume

(76) Inventors: Michael Brian Atwood, Half Moon Bay, CA (US); Robert Paul Garcia, San Jose, CA (US); Suresh Kumar Ramasamy, Redwood City, CA (US); Eduardo Comacho Lopez, Watsonville, CA (US)

Correspondence Address: David E. Lovejoy, 102 Reed Ranch Road, Tiburon, CA, 94920-2025, US

(21) Appl. No.: 10/330,373

(22) Filed: Dec. 27, 2002

(51) Int. Cl. H01Q 1/38

(52) U.S. Cl. 343/700 MS; 343/895; 343/741; 343/866; 343/702

(57) ABSTRACT

A finely-tuned, compressed antenna in a cube with one or more frequency bands and with high isolation between bands. The antenna is suitable for use in the front end of small, hand-held communications devices. The antenna includes one or more radiation elements, each element for operating in one or more of the bands. A radiation element is formed of a plurality of sections formed of electrically conducting segments where the segments are electrically connected to exchange energy in one or more of the bands of the radiation frequencies. One or more of the radiation elements has segments arrayed in a compressed pattern where the compressed pattern extends in three dimensions to fill a cube.

### BACKGROUND OF THE INVENTION

The present invention relates to the field of communication devices that communicate using radiation of electromagnetic energy and particularly relates to antennas and radio frequency (RF) front ends for such communication devices, particularly antennas for small communication devices carried by persons or communication devices otherwise benefitting from small-sized antennas and small-sized front ends.

Small communication devices include front-end components connected to base-band components (base components). The front-end components operate at RF frequencies and the base components operate at intermediate frequencies (IF) or other frequencies lower than RF frequencies. The RF front-end components for small devices have proved to be difficult to design, difficult to miniaturize and have added significant costs to small communication devices. The size of the antenna and its connection to the other RF components is critical in the quest for reducing the size of communication devices.

Communication devices that both transmit and receive with different transmit and receive bands typically use filters (duplexers, diplexers) to isolate the transmit and receive bands. Such communication devices typically employ broadband antennas that operate over frequency bands that are wider than the operating bands of interest and therefore the filters used to separate the receive (Rx) band and the transmit (Tx) band of a communication device operate to constrain the bandwidth within the desired operating receive (Rx) and the transmit (Tx) frequency bands. A communication device using transmit and receive bands for two-way communication is often referred to as a “single-band” communication device since the transmit and receive bands are usually close to each other within the frequency spectrum and are paired or otherwise related to each other for a common transmit/receive protocol. Dual-band communication devices use two pairs of transmit and receive bands, each pair for two-way communication. In multi-band communication devices, multiple pairs of transmit and receive bands are employed, each pair for two-way communication. In dual-band and other multi-band communication devices, additional filters are needed to separate the multiple bands and in addition, filters are also required to separate transmit and receive signals within each of the multiple bands. In standard designs, a Low Noise Amplifier (LNA) is included between the antenna and a mixer. The mixer converts between RF frequencies of the front-end components and lower frequencies of the base components.

The common frequency bands presently employed are US Cell, GSM 900, GSM 1800, GSM1900(PCS) where the frequency ranges are as follows:

| | Frequency Ranges |
|---|---|
| US Cell | 824-894 MHz |
| GSM 900 | 890-960 MHz |
| GSM 1800 | 1710-1880 MHz |
| GSM 1900 (PCS) | 1850-1990 MHz |

Communication Antennas Generally. In communication devices and other electronic devices, antennas are elements having the primary function of transferring energy to (in the receive mode) or from (in the transmit mode) the electronic device through radiation. Energy is transferred from the electronic device (in the transmit mode) into space or is transferred (in the receive mode) from space into the electronic device. A transmitting antenna is a structure that forms a transition between guided waves contained within the electronic device and space waves traveling in space external to the electronic device. The receiving antenna forms a transition between space waves traveling external to the electronic device and guided waves contained within the electronic device. Often the same antenna operates both to receive and transmit radiation energy.

Frequencies at which antennas radiate are resonant frequencies for the antenna. A resonant frequency, ƒ, of an antenna can have many different values as a function, for example, of dielectric constant of material surrounding an antenna, the type of antenna, the geometry of the antenna and the speed of light.

In general, wave-length, λ, is given by X=c/ƒ=cT where c=velocity of light (=3×10⁸ meters/sec), ƒ=frequency (cycles/sec), T=1/ƒ=period (sec). Typically, the antenna dimensions such as antenna length, Aₜ, relate to the radiation wavelength λ of the antenna. The electrical impedance properties of an antenna are allocated between a radiation resistance, Rᵣ, and an ohmic resistance, Rₒ. The higher the ratio of the radiation resistance, Rᵣ, to the ohmic resistance, Rₒ the greater the radiation efficiency of the antenna.

Antennas are frequently analyzed with respect to the near field and the far field where the far field is at locations of space points P where the amplitude relationships of the fields approach a fixed relationship and the relative angular distribution of the field becomes independent of the distance from the antenna.

Antenna Types. A number of different antenna types are well known and include, for example, loop antennas, small loop antennas, dipole antennas, stub antennas, conical antennas, helical antennas and spiral antennas. Such antenna types have often been based on simple geometric shapes. For example, antenna designs have been based on lines, planes, circles, triangles, squares, ellipses, rectangles, hemispheres and paraboloids. The two most basic types of electromagnetic field radiators are the magnetic dipole and the electric dipole. Small antennas, including loop antennas, often have the property that radiation resistance, Rᵣ, of the antenna decreases sharply when the antenna length is shortened.

An antenna radiates when the impedance of the antenna approaches being purely resistive (the reactive component approaches 0). Impedance is a complex number consisting of real resistance and imaginary reactance components. A matching network can be used to force resonance by eliminating reactive components of impedance for particular frequencies.

The RF front end of a communication device that operates to both transmit and receive signals includes antenna, filter, amplifier and mixer components that have a receiver path and a transmitter path. The receiver path operates to receive the radiation through the antenna. The antenna is matched at its output port to a standard impedance such as 50 ohms. The antenna captures the radiation signal from the air and transfers it as an electronic signal to a transmission line at the antennas output port. The electronic signal from the antenna enters the filter which has an input port that has also been matched to the standard impedance. The function of the filter is to remove unwanted interference and separate the receive signal from the transmit signal. The filter typically has an output port matched to the standard impedance. After the filter, the receive signal travels to a low noise amplifier (LNA) which similarly has input and output ports matched to the standard impedance, 50 ohms in the assumed example. The LNA boosts the signal to a level large enough so that other energy leaking into the transmission line will not significantly distort the receive signal. After the LNA, the receive signal is filtered with a high performance filter which has input and output ports matched to the standard impedance. After the high performance filter, the receive signal is converted to a lower frequency (intermediate frequency, IF) by a mixer which typically has an input port matched to the standard impedance.

The transmit path is much the same as the receive path. The lower frequency transmission signal from the base components is converted to an RF signal in the mixer and leaves the mixer which has a standard impedance output (for example, 50 ohms in the present example). The transmission signal from the mixer is “cleaned up” by a high performance filter which similarly has input and output ports matched to the standard impedance. The transmission signal is then buffered in a buffer amplifier and amplified in a power amplifier where the amplifiers are connected together with standard impedance lines, 50 ohms in the present example. The transmission signal is then connected to a filter, with input and output ports matched to the standard impedance. The filter functions to remove the remnant noise introduced by the receive signal. The filter output is matched to the standard impedance and connects to the antenna which has an input impedance matched to the standard impedance.

As described above, the antenna, filter, amplifier and mixer components that form the RF front end of a small communication device each have ports that are connected together from component port to component port to form a transmission path and a receive path. Each port of a component is sometimes called a junction. For a standard design, the junction properties of each component in the transmission path and in the receive path are matched to standard parameters at each junction, and specifically are matched to a standard junction impedance such as 50 ohms. In addition to impedance values, each junction is also definable by additional parameters including scattering matrix values and transmittance matrix values. The junction impedance values, scattering matrix values and transmittance matrix values are mathematically related so that measurement or other determination of one value allows the calculation of the others.

Typical front-end designs place constraints upon the physical junctions of each component and treat each component as a discrete entity which is designed in many respects independently of the designs of other components provided that the standard matching junction parameter values are maintained. While the discrete nature of components with standard junction parameters tends to simplify the design process, the design of each junction to satisfy standard parameter values (for example, 50 ohms junction impedance) places unwanted limitations upon the overall front-end design.

While many parameters may be tuned and optimized in RF front ends, the antenna is a critical part of the design. In order to miniaturize the RF front end, miniaturization of the antenna is important to achieve small size. In the prior applications entitled ARRAYED-SEGMENT LOOP ANTENNA (SC/Ser. No. 09/738,906) and LOOP ANTENNA WITH RADIATION AND REFERENCE LOOPS (SC/Ser. No. 09/815,928) assigned to the same assignee as the present application, compressed antennas were shown to render good performance with small sizes. Those antennas were compressed primarily on a two-dimensional basis by having multiple segments connected in snowflake, irregular and other compressed two-dimensional patterns. Some of those compressed antennas have relatively large “footprints,” that is, the size of the antennas on substrates, circuit boards or other planes is larger than is desired for high compression.

In consideration of the above background, there is a need for improved antennas having smaller “footprints” for miniaturizing the RF front ends of communication devices.

### SUMMARY

The present invention is a finely-tuned, compressed antenna in a cube with one or more frequency bands and with high isolation between bands. The antenna is suitable for use in the front end of small, hand-held communications devices. The antenna includes one or more radiation elements, each element for operating in one or more of the bands. A radiation element is formed of a plurality of sections formed of electrically conducting segments where the segments are electrically connected to exchange energy in one of the bands of the radiation frequencies. One or more of the radiation elements has segments arrayed in a compressed pattern where the compressed pattern extends in three dimensions to fill a cube.

In one embodiment, the antenna has the radiation elements deployed on a flexible substrate and the elements and the substrate are folded to fit within the cube.

In one embodiment, the antenna has a first one of the elements arrayed to form a loop with two electrical connections and in other embodiments, the antenna has an element arrayed with one electrical connection.

In one embodiment, the radiation element includes one or more connection pads for electrical connection to RF components of the communication device where the connection pads are deposited on the same substrate as the radiation element.

In one embodiment, the antenna terminates in one or more connection pads for surface mounting to a circuit board.

In one embodiment, the antenna has the bands include a US PCS band operating from 1850 MHz to 1990 MHz, a European DCS band operating from 1710 MHz to 1880 MHz, a European GSM band operating from 880 MHz to 960 MHz and a US cellular band operating from 829 MHz to 896 MHz.

The foregoing and other objects, features and advantages of the invention will be apparent from the following detailed description in conjunction with the drawings.

### BRIEF DESCRIPTION OF THE DRAWINGS

FIG. 1 depicts a schematic top view of one embodiment of an unfolded compressed antenna lying in a plane for deployment on a flexible substrate.

FIG. 2 depicts a schematic front view of the compressed antenna of FIG. 1 folded into a volume about dielectric spacers.

FIG. 3 depicts a schematic end view of the compressed antenna of FIG. 1 folded into a volume about dielectric spacers as shown in FIG. 2.

FIG. 4 depicts an isometric view of an a volume in the shape of a cube for housing the folded antenna of FIG. 2 and FIG. 3.

FIG. 5 depicts a schematic view of a top layer of another embodiment of an unfolded compressed antenna lying in a plane for deployment on a flexible substrate.

FIG. 6 depicts a schematic view of a bottom layer of the embodiment with the top layer of FIG. 5.

FIG. 7 depicts a schematic top view of another embodiment of an unfolded compressed antenna, having about the same size and shape as the antenna of FIG. 1, lying in a plane for deployment on substrate layers.

FIG. 8 depicts a schematic top view of layers lying in a plane employed for the antenna of FIG. 7.

FIG. 9 depicts a front view of the stacked layers of FIG. 8 exploded in the vertical direction for ease of viewing.

FIG. 10 depicts a two-dimensional representation of the field pattern of the antenna structure of FIG. 1 for the GSM 900 bands.

FIG. 11 depicts a two-dimensional representation of the field pattern of the antenna structure of FIG. 1 for the GSM 1800 or DCS 1800 bands.

FIG. 12 depicts a two-dimensional representation of the field pattern of the antenna structure of FIG. 1 for the GSM PCS 1900, bands.

FIG. 13 depicts a two-dimensional representation of the field pattern of the antenna structure of FIG. 5 and FIG. 6 for the GSM 900 bands.

FIG. 14 depicts a two-dimensional representation of the field pattern of the antenna structure of FIG. 5 and FIG. 6 for the GSM 1800 or DCS 1800 bands.

FIG. 15 depicts a two-dimensional representation of the field pattern of the antenna structure of FIG. 5 and FIG. 6 for the GSM PCS 1900 bands.

FIG. 16 depicts a voltage standing wave ration (VSWR) representation of the antenna of FIG. 5 and FIG. 6.

FIG. 17 depicts a Smith chart representation for the antenna of FIG. 5 and FIG. 6.

FIG. 18 depicts a schematic view of a small communication device with RF front-end functions including separate transmit and receive antennas, filters and other RF function components and lower frequency base components.

FIG. 19 depicts a schematic view of a small communication device with RF front-end functions including a common antenna for transmitting and receiving and separate filter and other RF function components for transmitting and receiving and including lower frequency base components.

FIG. 20 depicts a schematic view of a dual-band small communication device with RF front-end functions including integrated antenna/filter functions for transmit and receive, paths in all bands and including lower frequency base components.

FIG. 21 depicts a schematic view of a multi-band small communication device with RF front-end functions including a common antenna function for all bands.

FIG. 22 depicts a schematic view of a multi-band small communication device with RF front-end functions including separate antenna functions for each band.

FIG. 23 depicts a schematic view of a multi-band small communication device with RF front-end functions including separate antenna functions for each band.

FIG. 24 depicts a schematic view of a multi-band small communication device with RF front-end functions including separate antenna functions for each band.

FIG. 25 depicts a representation of a front view of a cellular phone representative of a small communication devices employing antennas of the present application.

FIG. 26 depicts a representation of an end view of the cellular phone of FIG. 25.

FIG. 27 depicts a top view of unstacked layers, lying in a base plane, of another embodiment of an antenna.

FIG. 28 depicts a top view, a front view and a bottom view of the layers of FIG. 27 stacked together to form a compressed cube antenna in a volume.

FIG. 29 depicts a representation of a front view of a cellular phone representative of a small communication device employing the compressed antenna of FIG. 28.

FIG. 30 depicts a representation of an end view of the cellular phone of FIG. 29 taken along a section line 30′-30″ in FIG. 29.

### DETAILED DESCRIPTION

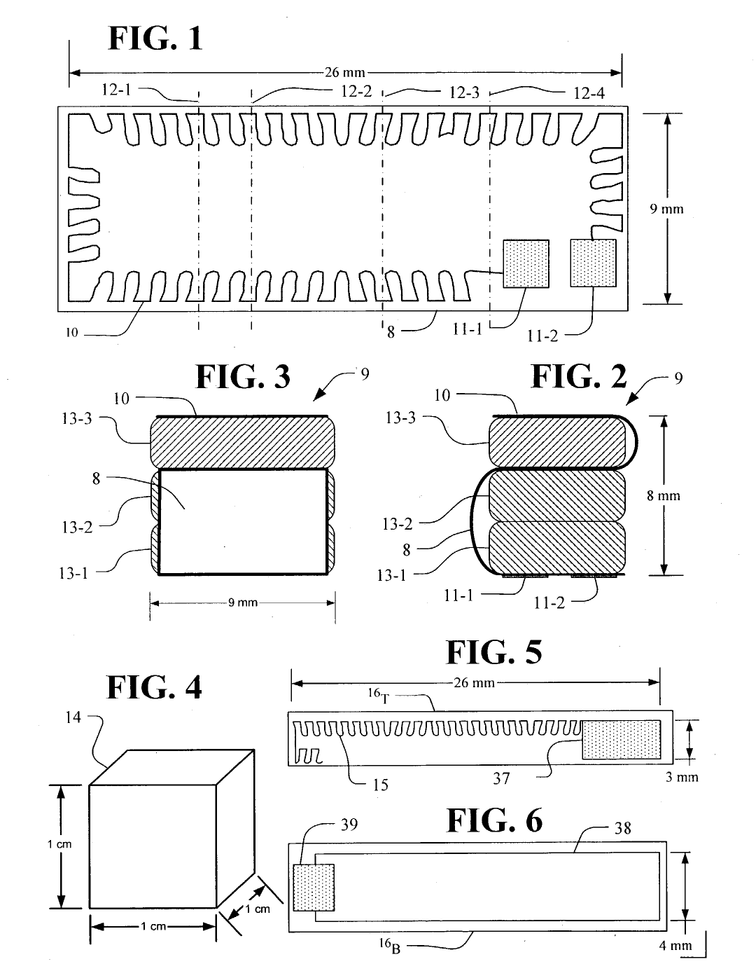

FIG. 1 depicts a schematic top view of one embodiment of an unfolded compressed antenna conductor 10 lying in a plane (the plane of the drawing) deployed on a flexible substrate 8. In FIG. 1, the antenna conductor 10 is formed in a loop between connection pads 11-1 and a 11-2. The overall outside dimensions of the antenna conductor 10 are approximately 10 mm by 26 mm The antenna conductor 10 is intended to be folded into a volume along the folding lines 12-1, 12-2, 12-3 and 12-4.

FIG. 2 depicts a schematic front view of the compressed antenna 9 and includes the antenna conductor 10 on substrate 8, as shown in FIG. 1, folded into a volume about dielectric spacers 13-1, 13-2 and 13-3. The connection pads 11-1 and 11-2 at the bottom of the volume including the dialect spacers 13-1, 13-2 and 13-3, the flexible substrate 8 and the antenna conductor 10. The configuration of the components for antenna 9 has a height of approximately 8 mm.

FIG. 3 depicts a schematic end view of the compressed antenna 9 of FIG. 2 and includes the antenna conductor 10 on substrate 8 folded into a volume about dielectric spacers 13-1, 13-2 and 13-3. The connection pads 11-1 and 11-2 are at the bottom of the column that includes dialect spacers 13-1, 13-2 and 13-3, flexible substrate 8 and the antenna conductor 10.

FIG. 4 depicts an isometric view of an a volume in the shape of a cube for housing the folded antenna of FIG. 2 and FIG. 3. The dimensions of the cube 14 are approximately 1 cm by 1 cm by 1 cm. The cube 14 is constructed from dielectric or other material which does not interfere with the radiation of an antenna, such as antenna 9 of FIG. 2 and FIG. 3. For purposes of this specification, the term “cube” means any solid volume that is three-dimensional so to support a compressed antenna. A compressed antenna is one where the antenna conductor, like antenna conductor 10, is formed of a conducting trace that turns back and forth in many segments so that the electrical length is much greater than is present for a trace formed by simple regular geometries such as circular loops, squares, rectangles and similar simple shapes. A compressed antenna in a cube, that is in a volume, is formed of a conducting trace that turns back and forth in many segments arrayed in three dimensions.

FIG. 5 depicts a schematic view of a top layer of another embodiment of an unfolded compressed antenna conductor 15 lying in a plane (the plane of the drawing) deployed on the top 16_{T} of a flexible substrate. In FIG. 5, the antenna conductor 15 is formed as a stub antenna having an unclosed trace connected to pad 37. The overall outside dimensions of the antenna conductor 15 are approximately 3 mm by 26 mm. The antenna conductor 15 and substrate 16_{T} are constructed of material that can be folded into a volume in the same manner as the FIG. 1 conductor 10 and substrate 8 are folded.

FIG. 6 depicts a schematic view of the bottom layer of the embodiment of FIG. 5. The bottom 16_{B} of the flexible substrate in FIG. 6 is the opposite side of the top 16_{T} in FIG. 5. In FIG. 6, the antenna conductor 38 is formed as a closed loop connected to a pad 39. The pad 39 is at the opposite end from then pad 37 in FIG. 5. The loop 38 is approximately 4 mm wide and 26 mm long so as to circle the perimeter of the conductor 15 and pad 37 of FIG. 5.

When the FIG. 5 and FIG. 6 components are folded into a volume, in the same manner as the components in FIG. 1, the appearance is substantially the same as FIG. 2 and FIG.3 except that the FIG. 5 and FIG. 6 components are more narrow than the FIG. 1 components.

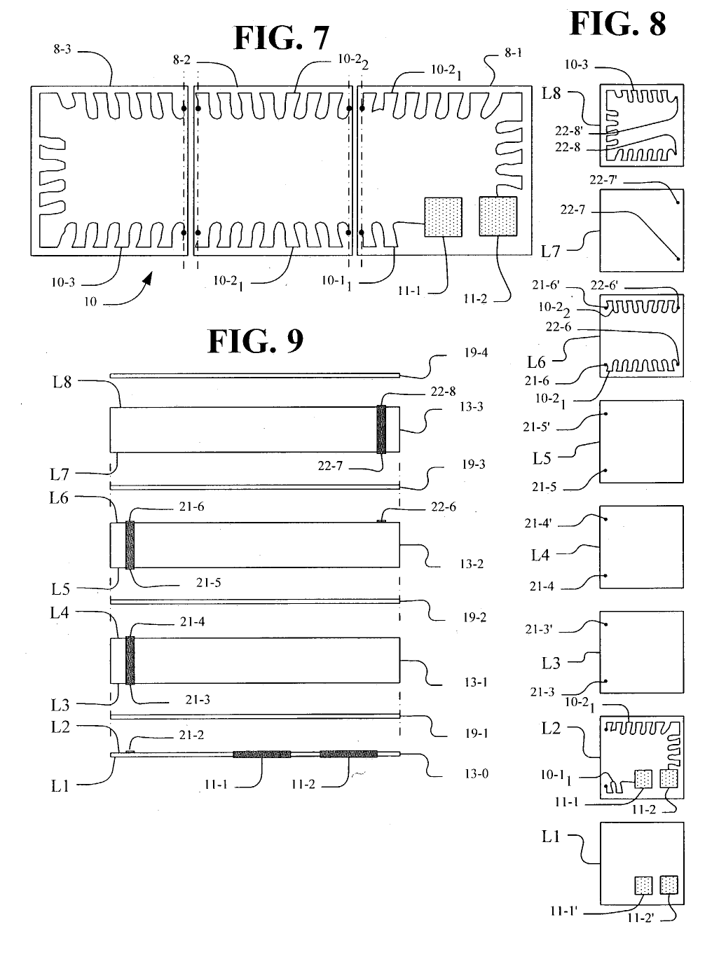

FIG. 7 depicts a schematic top view of another embodiment of an unfolded compressed antenna, having about the same size and shape as the antenna of FIG. 1, lying in a plane (the plane of the drawing) for deployment on substrate layers stacked in a volume.

In FIG. 7, in the conductor 10 is formed in sections 10-1, 10-2 and 10-3 where section 10-1 includes sections 10-1₁ and 10-2₂ and section 10-2 and includes sections 10-2₁ and 10-2₂. The substrate 8, the FIG. 1 is broken into or otherwise formed into three substrates 8-1, 8-2 and 8-3. The substrate 8-1 includes the pads 11-1 and 11-2 and the sections 10-1₁ and that 10-2₁. The substrate 8-2 supports the conductor's 10-2₁ and 10-2₂. The substrate 8-3a supports the conductor 10-3. The substrate so 8-1, 8-2 and 8-3 are combined with other intermediate media layers to form a stack of layers to form the antenna volume.

FIG. 8 depicts a schematic view of layers lying in a plane (the plane of the paper) that are employed for the antenna components of FIG. 7. In the 8, the layers that are to be assembled to form the antenna in a volume are shown as layers L1, L2, . . . , L8. The layer L1 is the bottom most layer and includes The connection pads 11-1′ and 11-2′ that are used to connect the final antenna to an external circuit. The layer L2 includes the conductor section 10-1₁ connected to the pad 11-1 at one end and the connection point 21-3 at the other and the conductor section 10-2₁ connects to the pad 11-2 at one end and connects to the connection point 21-3′ at the other. The layer L2 is essentially the same as the layer on substrate 8-1 in FIG. 1 and includes the pad 11-1 and the pad 11-2. Pad 11-1 connects to the conductor section 10-1₁ and the pad 11-2 connects to the conductor section 10-2₁. The layer L3 is the bottom of dielectric separator and includes the openings 21-3 and a 21-3′. The layer L4 is the top of the dielectric separator and includes the openings 21-4 and 21-4′ which are in alignment with the openings 21-3 and 21-3′ for layer L3. The layer L5 is the bottom of another dielectric separator and includes the openings 21-5 and 21-5′ which are in alignment with the openings 21-4 and 21-4′ for layer L4. The layer L6 is the top of the dielectric separator and includes the conductor section 10-2₁ that connects to the connection point 21-6 at one end and connects to the connection point 22-6′ at the other end. The conductor section 10-2₂ connects to the connection point. 21-6 at one end and connects to the connection point 22-6′ at the other end. The layer L7 is the bottom of another dielectric separator and includes the openings 22-7 and 22-7′ that are in alignment connection point. 22-6 and 22-6′. The layer L8 includes the conductor section 10-3 which connects between the connection points 22-8 and 22-8′.

FIG. 9 depicts a front view of the stacked layers of FIG. 8 exploded in the vertical direction for ease of viewing. In the FIG. 9, the layers that are assembled to form the antenna in a volume are layers L1, L2, . . . , L8 and additionally separators 19-1, 19-2 and 19-3. A similar member 19-4 is positioned on top of the layer L8. The members 19-1, 19-2, 19-3 and 19-4 are typically adhesive or other dielectric material that does not interfere with operation of the antenna. The layer L1 is the bottom most layer and includes The connection pads 11-1′ and 11-2′ that are used to connect the assembled antenna to an external circuit. The layer L2 is separated from layer L1 by member 19-1. The layer L2 is essentially the same as the layer on substrate 8-1 in FIG. 1 and includes the pad 11-1 and the pad 11-2. The layer L3 is the bottom of dielectric separator 13-1 and includes the through-layer connection end 21-3 (and 21-3′ behind and not shown). The layer L3 is separated from layer L2 by dielectric member or material 19-1. The layer L4 is the top of the dielectric separator 13-1 and includes the through-layer connection end 21-4 (and 21-4′ behind and not shown) which are in alignment with the through-layer connection end 21-3 (and 21-3′ behind and not shown) for layer L3. The layer L5 is separated from layer L4 by dielectric member or material 19-2. The layer L5 is the bottom of another dielectric separator 13-2 and includes the through-layer connection end 21-5 (and 21-5′ behind and not shown) which are in alignment with the through-layer connection end 21-4 (and 21-4′ behind and not shown) for layer L4. The layer L6 is the top of the dielectric separator 13-2 and includes a connection point 22-6 (and connection point 22-6′ behind and not shown). The layer L7 is the bottom of another dielectric separator 13-3 and includes the opening 22-7 (and 22-7′ behind not shown) that are in alignment connection point. 22-6 (and 21-6′ behind and not shown). The layer L7 is separated from layer L6 by dielectric member or material 19-3. The layer L8 includes the conductor section 10-3 which connects between the through-layer connection point 22-8 (and 21-8′ behind and not shown).

The antenna of FIG. 9 when assembled in the collapsed formed has the same width and height as the antenna FIG. 2 and FIG. 3 and therefore fits within the cube 14 of FIG. 4.

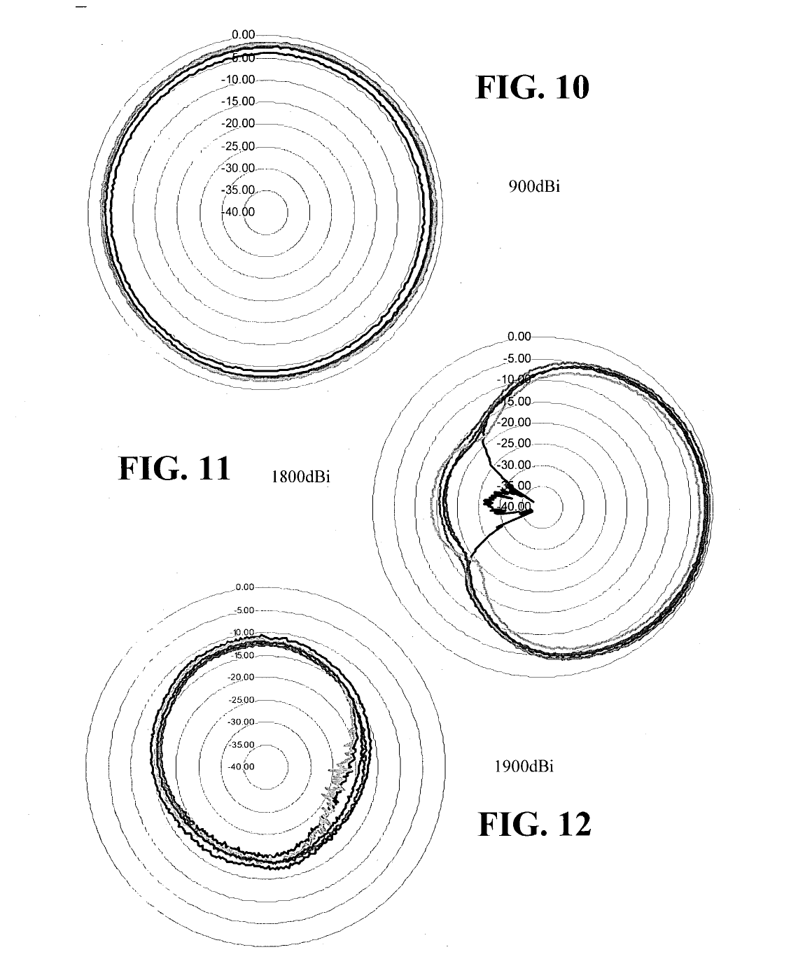

FIG. 10 depicts a two-dimensional representation of the field pattern of the antenna formed in a volume as described in connection with FIG. 1 through FIG. 4 for the GSM 900 bands.

FIG. 11 depicts a two-dimensional representation of the field pattern of the antenna formed in a volume as described in connection with FIG. 1 through FIG. 4 for the GSM 1800 or DCS 1800 bands.

FIG. 12 depicts a two-dimensional representation of the field pattern of the antenna formed in a volume as described in connection with FIG. 1 through FIG. 4 for the PCS 1900 bands.

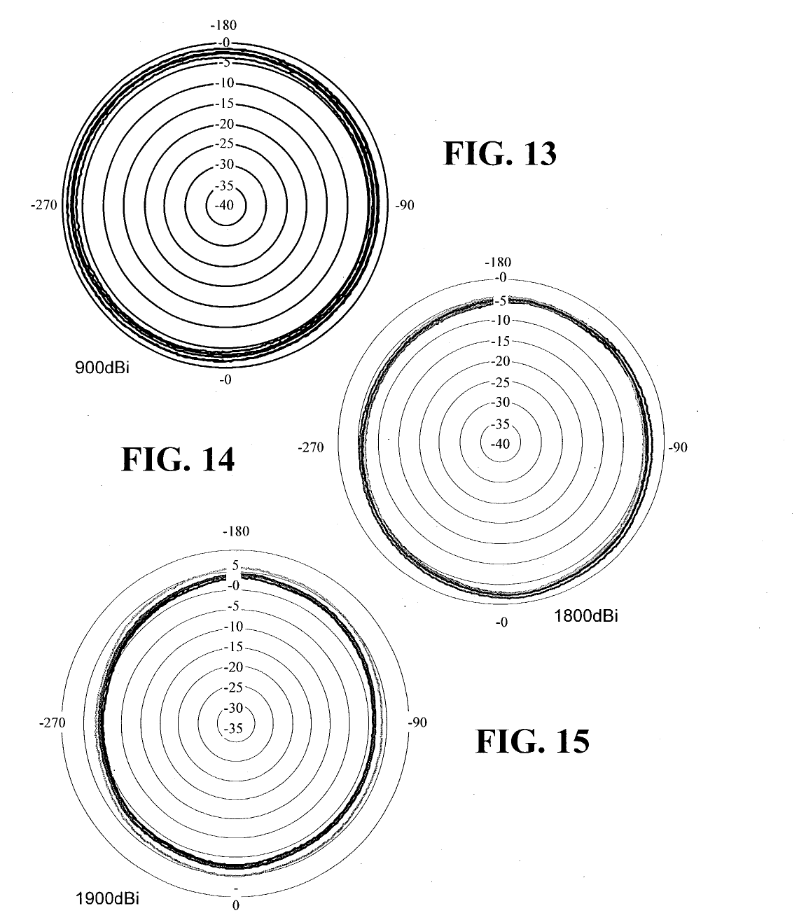

FIG. 13 depicts a two-dimensional representation of the field pattern of the antenna structure of FIG. 5 and FIG. 6 for the GSM 900 bands.

FIG. 14 depicts a two-dimensional representation of the field pattern of the antenna structure of FIG. 5 and FIG. 6 for the GSM 1800 or DCS 1800 bands.

FIG. 15 depicts a two-dimensional representation of the field pattern of the antenna structure of FIG. 5 and FIG. 6 for the GSM PCS 1900 bands.

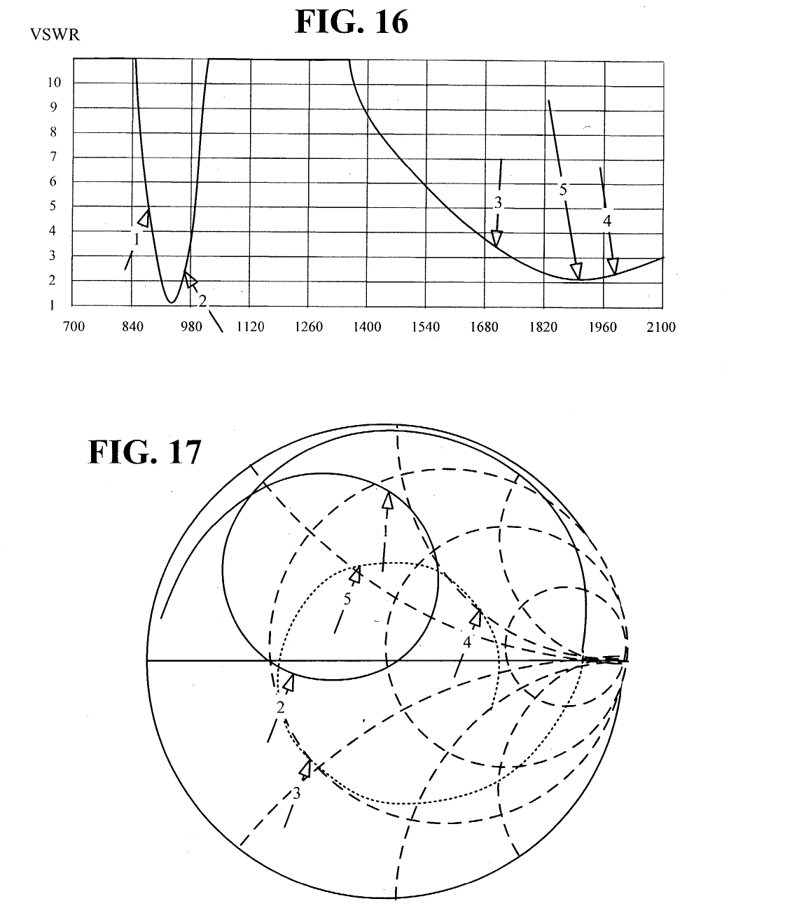

FIG. 16 depicts a voltage standing wave ration (VSWR) representation of the antenna of FIG. 5 and FIG. 6.

FIG. 17 depicts a Smith chart representation for the antenna of FIG. 5 and FIG. 6.

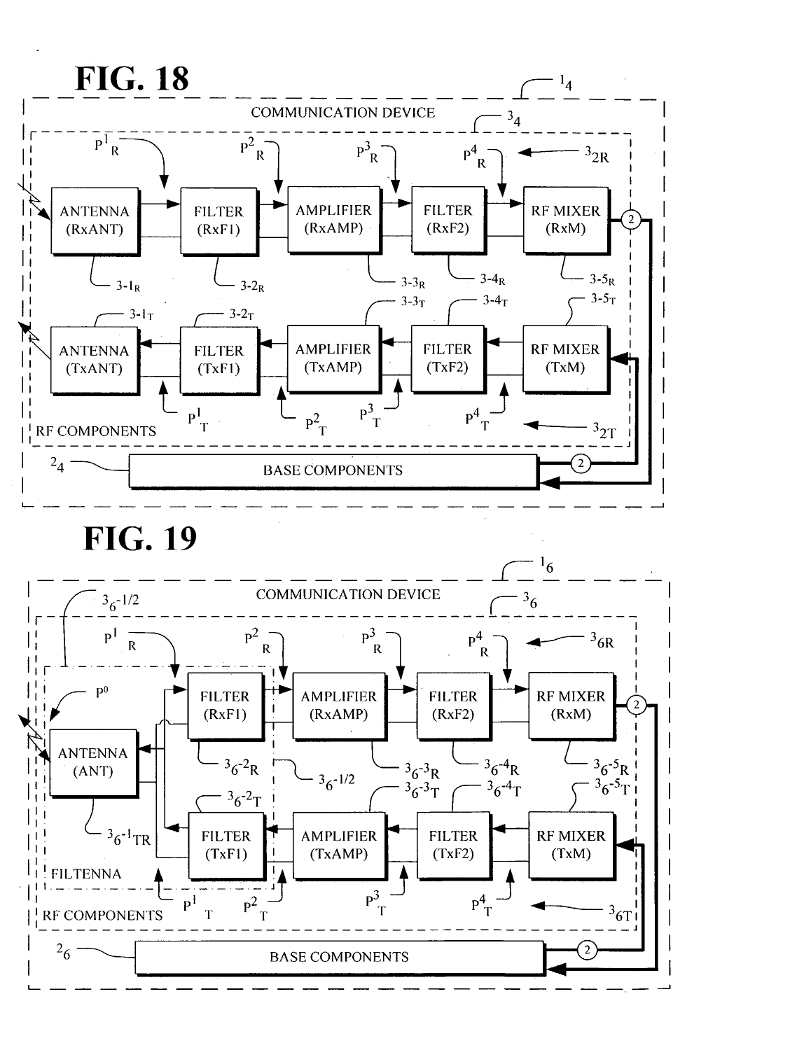

FIG. 18 depicts a schematic view of a small communication device with RF front-end functions that benefit from antennas described in the present specification. The small communication device includes separate transmit and receive antennas, filters and other RF function components and lower frequency base components incorporating the antennas described in various embodiments.

In FIG. 18, the small communication device 1₄ includes RF front-end components 3₄ and base components 2₄. The RF components perform the RF front-end functions and have both a receive path 3_{2R} and a transmit path 3_{2T}. The receive path 3_{2R} includes an antenna function 3-1_{R}, a filter function 3-2_{R}, an amplifier function 3-3_{R}, a filter function 3-4_{R} and a mixer function 3-5_{R}. The antenna function 3-1_{R} is for converting between received radiation and electronic signals, the filter function 3-2_{R} is for limiting signals within an operating frequency band for the receive signals, the amplifier function 3-3_{R} is for boosting receive signal power, the filter function 3-4_{R} is for limiting signals within the operating frequency receive band, and the mixer function 3-5_{R} is for shifting frequencies between RF receive signals and lower frequencies.

The transmit path 3_{2R} includes a mixer function 3-5_{T}, a filter function 3-4_{T}, an amplifier function 3-3_{T}, a filter function 3-2_{T}, and an antenna function 3-1_{T}. The mixer function 3-5_{T} is for frequencies between lower frequencies and RF transmit signals, the filter function 3-4_{T} is for limiting signals within the operating frequency transmit band, the amplifier function 3-3_{T} is for boosting transmit signal power, the filter function 3-2_{T} is for limiting signals within operating frequency band for the transmit signals, and the antenna function 3-1_{T} is for converting between electronic signals and the transmitted radiation.

In FIG. 18, the RF front-end functions are connected by junctions. The junction P¹_{R} is between antenna function 3-1_{TR} and filter functions 3-2_{R}, the junction P²_{R} is between filter function 3-2_{R} and the amplifier function 3-3_{R}, the junction P³_{R} is between amplifier function 3-3_{R} and filter function 3-4_{R} and the junction P⁴_{R} is between filter function 3-4_{R} and mixer function 3-5_{R}. The junction P¹_{T} is between antenna function 3-1_{T} and filter functions 3-2_{T}, the junction P²_{T} is between filter function 3-2_{T} and the amplifier function 3-3_{T}, the junction P³_{T} is between amplifier function 3-3_{T} and filter function 3-4_{T} and the junction P⁴_{T} is between filter function 3-4_{T} and mixer function 3-5_{T}.

In the embodiment of FIG. 18, the junctions P¹_{R}, P²_{R}, P³_{R} and P⁴_{R} correspond to ports of the filter 3-2_{R} amplifier 3-3_{R}, filter 3-4_{R} and mixer 3-5_{R} components and the junctions P⁴_{T}, P³_{T}, P²_{T}, and P²_{T} correspond to ports of mixer 3-5_{T}, filter 3-4_{T}, amplifier 3-3_{T} and filter 3-4_{T} components.

FIG. 19 depicts a schematic view of a small communication device with RF front-end functions including a common antenna for transmitting and receiving and separate filter and other RF function components for transmitting and receiving and including lower frequency base components incorporating antennas described in various embodiments.

FIG. 19 depicts a schematic view of a small communication device 1₆ RF front-end components 3₆ and base components 2₆. The RF components perform the RF front-end functions and have both a receive path 3_{6R} and a transmit path 3_{6T}. The receive path 3_{6R} includes common antenna function 3₆-1_{TR}, a filter function 3₆-2_{R}, an amplifier function 3₆-3_{R}, a filter function 3₆-4_{R} and a mixer function 3₆-5_{R}. The antenna function 3₆-1_{TR} is for converting between received radiation and electronic signals, the filter function 3₆-2_{R} is for limiting signals within an operating frequency band for the receive signals, the amplifier function 3₆-3_{R} is for boosting receive signal power, the filter function 3₆-4_{R} is for limiting signals within the operating frequency receive band, and the mixer function 3₆-5_{R} is for shifting frequencies between RF receive signals and lower frequencies.

The transmit path 3_{6T} includes a mixer function 3₆-5_{T}, a filter function 3₆-4_{T}, an amplifier function 3₆-3_{T}, and common antenna function 3₆-1_{TR}, a filter function 3₆-2_{T}, and an antenna function 3₆-1_{TR}. The mixer function 3₆-5_{T} is for shifting frequencies between lower frequencies and RF transmit signals, the filter function 3₆-4_{T} is for limiting signals within the operating frequency transmit band, the amplifier function 3₆-3_{T} is for boosting transmit signal power, the filter function 3₆-2_{T} is for limiting signals within operating frequency band for the transmit signals, and the antenna function 3₆-1_{TR} is for converting between electronic signals and transmitted radiation.

In FIG. 19, the RF front-end functions are connected by junctions. The junction P¹_{R} is between antenna function 3₆-1_{TR} and filter functions 3₆-2_{R}, the junction P²_{R} is between filter function 3₆-2_{R} and the amplifier function 3₆-3_{R}, the junction P³_{R} is between amplifier function 3₆-3_{R} and filter function 3₆-4_{R} and the junction P⁴_{R} is between filter function 3₆-4_{R} and mixer function 3₆-5_{R}. The junction P¹_{T} is between antenna function 3₆-1_{TR} and filter function 3₆-2_{T}, the junction P²^{T} is between filter function 3₆-2_{T} and the amplifier function 3₆-3_{T}, the junction P³_{T} is between amplifier function 3₆-3_{T} and filter function 3₆-4_{T} and the junction P⁴_{T} is between filter function 3₆-4_{T} and mixer function 3₆-5_{T}.

In the embodiment of FIG. 19, the junctions P¹_{R}, P²_{R}, P³_{R} and P⁴_{R} correspond to ports of filter 3₆-2_{R}, amplifier 3₆-3_{R}, filter 3₆-4_{R} and mixer 3₆-5_{R} and the junctions P⁴_{T}, P³_{T}, P²_{T} and P¹_{T} correspond to ports of mixer 3₆-5_{T}, filter 3₆-4_{T}, amplifier 3₆-3_{T} and filter 3₆-2_{T}. The antenna function 3₆-1_{TR} and the filter functions 3₆-2_{R} and 3₆-2_{T} in one embodiment are in a common antenna/filter unit 3₆-1/2.

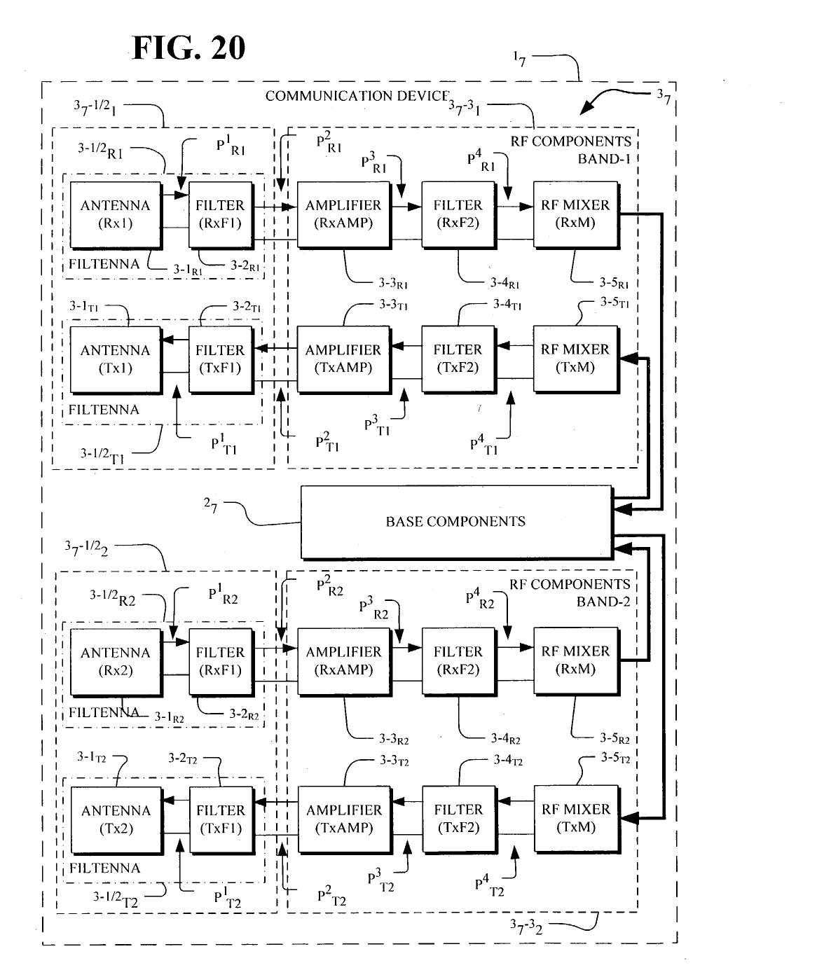

FIG. 20 depicts a schematic view of a dual-band small communication device with RF front-end functions including integrated antenna/filter functions for transmit and receive paths in all bands and including lower frequency base components incorporating antennas described in various embodiments.

FIG. 20 depicts a schematic view of a small communication device 1₇ with base components 2₇ and RF front-end components 3₇. The front-end components 3₇ include front-end components 3₇-1/2₁, front-end components 3₇-1/2₂, front-end components 3₇-3₁ and front-end components 3₇-3₂. The RF components 3₇ perform the RF front-end functions for two different bands, Band-1 and Band-2. Each band has separate antenna/filter unit components. Band-1 includes antenna/filter unit components 3₇-1/2₁ and front-end components 3₇-3₁. Band-2 includes antenna/filter unit component 3₇-1/2₂ and front-end components 3₇-3₂. Both Band-1 and Band-2 have a receive path and a transmit path.

For Band-1, the receive path includes an antenna function 3-1_{R1}, a filter function 3-2_{R1}, an amplifier function 3-3_{R1}, a filter function 3-4_{R1} and a mixer function 3-5_{R1}. The antenna function 3-1_{R1} is for converting between radiated and electronic signals, the filter function 3-2_{R1} is for limiting signals within operating frequency band for the receive signals, the amplifier function 3-3_{R1} is for boosting receive signal power, the filter function 3-4_{R1} is for limiting signals within the operating frequency receive band, and the mixer function 3-5_{R1} is for shifting frequencies between RF receive signals and lower frequencies. For Band-1, the transmit path includes an antenna function 3-1_{T1}, a filter function 3-2_{T1}, an amplifier function 3-3_{T1}, a filter function 3-4_{T1} and a mixer function 3-5_{T1}. The antenna function 3-1_{R1} is for converting between radiated and electronic signals, the filter function 3-2_{T1} is for limiting signals within operating frequency band for the transmit signals, the amplifier function 3-3_{T1} is for boosting transmit signal power, the filter function 3-4_{T1} is for limiting signals within the operating frequency transmit band, and the mixer function 3-5_{T1} is for shifting frequencies between RF transmit signals and lower frequencies.

For Band-2, a receive path and a transmit path are present. The receive path includes an antenna function 3-1_{R2}, a filter function 3-2_{R2}, an amplifier function 3-3_{R2}, a filter function 3-4_{R2} and a mixer function 3-5_{R2}. The antenna function 3-1_{R2} is for converting between radiated and electronic signals, the filter function 3-2_{R2} is for limiting signals within operating frequency band for the receive signals, the amplifier function 3-3_{R2} is for boosting receive signal power, the filter function 3-4_{R2} is for limiting signals within the operating frequency receive band, and the mixer function 3-5_{R2} is for shifting frequencies between RF receive signals and lower frequencies. For Band-2, the transmit path includes an antenna function 3-1_{T2}, a filter function 3-2_{T2}, an amplifier function 3-3_{T2}, a filter function 3-4_{T2} and a mixer function 3-5_{T2}. The antenna function 3-1_{T2} is for converting between radiated and electronic signals, the filter function 3-2_{T2} is for limiting signals within operating frequency band for the transmit signals, the amplifier function 3-3_{T2} is for boosting transmit signal power, the filter function 3-4_{T2} is for limiting signals within the operating frequency transmit band, and the mixer function 3-5_{T2} is for shifting frequencies between RF transmit signals and lower frequencies.

In FIG. 20, for Band-1 and Band-2, the front-end RF functions are connected by junctions. For Band-1 for the receive path, the junctions P²_{R1}, P³_{R1} and P⁴_{R1} are located at ports of amplifier 3-3_{R1}, filter 3-4_{R1} and mixer 3-5_{R1} and the junctions P⁴_{T1}, P³_{T1} and P²_{T1} are located at ports of mixer 3-5_{T1}, filter 3-4_{T1} and amplifier 3-3_{T1}. The antenna function 3-1_{R1} and the filter functions 3-2_{R1} are integrated into a common integrated component, antenna/filter unit 3-1/2_{R1} so that the P¹_{R1} junction parameters are integrated and not separately tuned. The parameters for junction P²_{R1} are tuned for the combined antenna function 3-1_{R1} and the filter function 3-2_{R1}. The integrated filter and antenna of the antenna/filter unit component 3-1/2_{R1} are characterized by the junction properties at the port having parameters for junction P²_{R1}. In particular, the junction impedance or other parameters which may exist at the P¹_{R1} junction are not tuned to provide standard values, such as a 50 ohm matching impedance, but are permitted to assume values dependent on the desired values for junction parameters at the P²_{R2} junction.

For Band-1 for the transmit path, the junctions P¹_{T1}, P²_{T1}, P³_{T1} and P⁴_{T1} are located at ports of filter 3-2_{T1} amplifier 3-3_{T1}, filter 3-4_{T1} and mixer 3-5_{T1} and the junctions P⁴_{T1}, P³_{T1}, P²_{T1} and P¹_{T1} are located at ports of mixer 3-5_{T1}, filter 3-4_{T1}, amplifier 3-3_{T1} and filter 3-2_{T1}. The antenna function 3-1_{T1} and the filter functions 3-2_{T1} are in an antenna/filter unit 3-1/2_{T1}. The parameters for junctions P¹_{T1} and P²_{T1} are tuned for the antenna function 3-1_{T1} and the filter function 3-2_{T1}.

For Band-2 for the receive path, the junctions P¹_{R2}, P²_{R2}, P³_{R2} and P⁴_{R2} are located at ports of filter 3-2_{R2}, amplifier 3-3_{R2}, filter 3-4_{R2} and mixer 3-5_{R2} and the junctions P⁴_{T1}, P³_{T1}, P²_{T1} and P¹_{T1} are located at ports of mixer 3-5_{T1}, filter 3-4_{T1}, amplifier 3-3_{T1} and filter 3-2_{T1}. The antenna function 3-1_{R2} and the filter functions 3-2_{R2} are in an antenna/filter unit 3-1/2_{R2} so that the junction parameters P¹_{R2} and P²_{R2} are tuned for the antenna function 3-1_{R2} and the filter function 3-2_{R2}.

For Band-2 for the transmit path, the junctions P¹_{T2}, P²_{T2}, P³_{T2} and P⁴_{T2} are located at ports of filter 3-2_{T2}, amplifier 3-3_{T2}, filter 3-4_{T2} and mixer 3-5_{T2} and the junctions P⁴_{T2, P}³_{T2}, P²_{T2} and P¹_{T2} are located at ports of mixer 3-5_{T2}, filter 3-4_{T2}, amplifier 3-3_{T2} and filter 3-2_{T2}. The antenna function 3-1_{T2} and the filter functions 3-2_{T2} are in an antenna/filter unit 3-1/2_{T2} so that the junction parameters for junctions P¹_{T2} and P²_{T2} are tuned for the combined antenna function 3-1_{T2} and the function 3-2_{T2}.

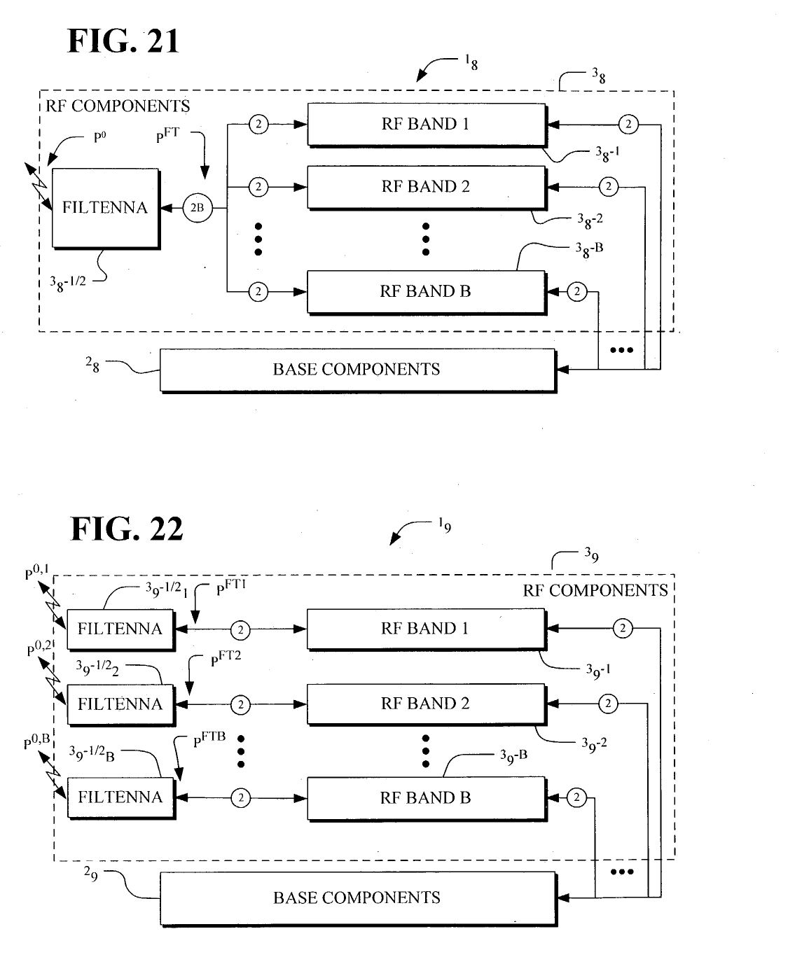

FIG. 21 depicts a schematic view of a multi-band small communication device with RF front-end functions including a separate antenna function for transmit and receive paths in each band and including lower frequency base components incorporating antennas described in various embodiments.

FIG. 21 depicts a schematic view of a multi-band small communication device 1₈ with RF front-end components 3₈ and base components 2₈. The RF components perform the RF front-end functions that include antenna, filter, amplifier and mixer functions.

In FIG. 21, the antenna function and the filter function are integrated in antenna/filter unit 3₈-1/2 so that the internal antenna and filter junction parameters are integrated. The parameters of junction P^{FT} for antenna/filter unit 3₈-1/2 are tuned for the integrated antenna and filter functions. The antenna/filter unit 3₈-1/2 connects to B RF bands 1, 2, . . . , B in front-end components 3₈-1, 3₈-2, . . . , 3₈-B, respectively, where each band includes a transmit and receive path. The antenna/filter unit 3₈-1/2 in one embodiment is a component with [2(B)+1] ports that is characterized at junction P^{FT} by a [2(B)+1]-by-[2(B)+1] scattering matrix.

FIG. 22 depicts a schematic view of a multi-band small communication device 1₉ with RF front-end components 3₉ and base components 2₉. The RF components perform the RF front-end functions that include antenna, filter, amplifier and mixer functions incorporating antennas described in various embodiments.

In FIG. 22, the antenna function and the filter function are in a plurality of antenna/filter units 3₉-1/2₁, 3₉-1/2₂, . . . , 3₉-1/2_{B}, one for each of the bands 1, 2, . . . , B, respectively, where each band includes a transmit and receive path. The internal antenna and filter junction parameters P^{FT1}, P^{FT2}, P^{FTB} of antenna/filter units 3₉-1/2₁, 3₉-1/2₂, . . . , 3₉-1/2_{B} are each tuned for the combined antenna and filter functions of each band. In one embodiment, the antenna/filter units 3₉-1/2₁, 3₉-1/2₂, . . . , 3₉-1/2_{B} are each three-port components withe the radiation interface junctions P^{0,1}, P^{0,2}, . . . , P^{0,B} and the junctions P^{FT1}, P^{FT2}, . . . , P^{FTB}, respectively. The antenna/filter units 3₉-1/2₁, 3₉-1/2₂, . . . , 3₉-1/2_{B} each connect to a corresponding one of the front-end components 3₉-1, 3₉-2, . . . , 3₉-B, respectively. According, in the one embodiment, the scattering matrix for each component is for a 3-port device and antenna/filter units 3₉-1/2₁, 3₉-1/2₂, . . . , 3₉-1/2_{B} are tuned accordingly.

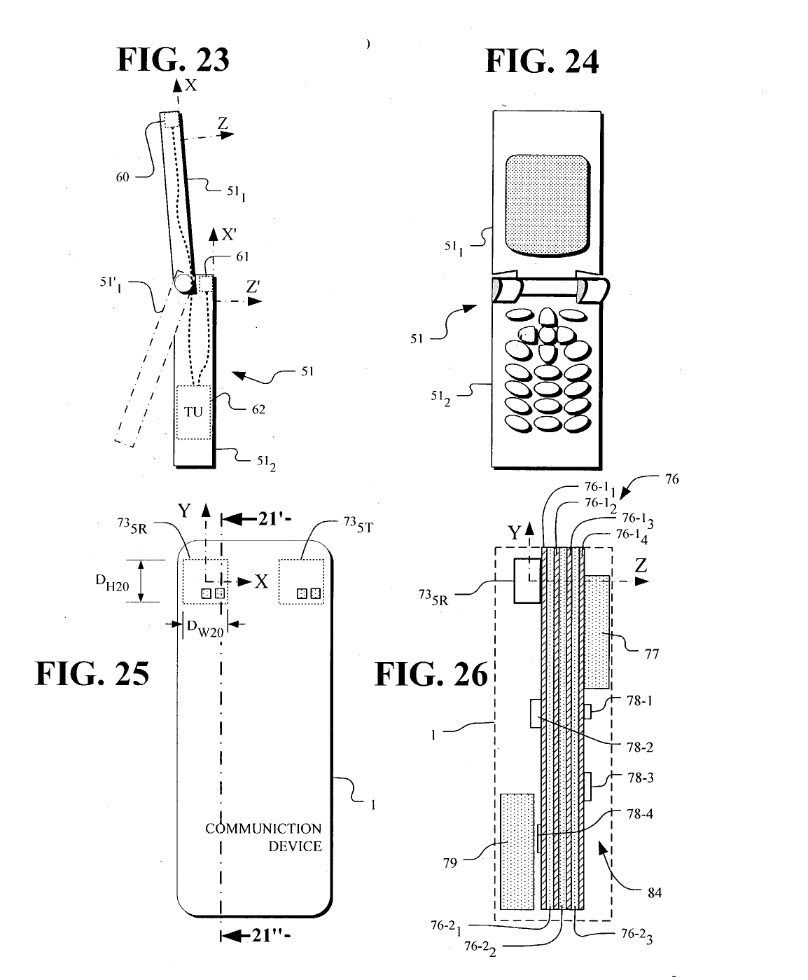

In FIG. 23, communication device 51 is a cell phone, pager or other similar communication device that can be used in close proximity to people. The communication device 51 includes a flip portion 51₁ shown solid in the open position and shown as 51′₁ in broken-line representing a near closed position. The communication device 51 includes a base portion 51₂. The communication device 51 includes antenna areas allocated for antennas 60 and 61 which receive and transmit, respectively. The antenna 61 is located in the base portion 51₂ shown and the antenna 60 is located in the flip portion 51₁. In FIG. 23, the antenna volumes for antennas 60 and 61 are small so as to fit within the base and flip portions of the device 51.

In FIG. 24, communication device 51 is shown with-flip portion 51₁ open above base portion 51₂.

In FIG. 25, communication device 1 is a cell phone, pager or other similar communication device that can be used in close proximity to people. The communication device 1 includes antenna areas allocated for an antennas 3_{5R} and 3_{5T} which receive and transmit, respectively, radio wave radiation for the communication device 1. In FIG. 5, the antenna areas have widths D_{W} and heights D_{H}. A section line 6′-6″ extends from top to bottom of the communication device The communication device 1 is typically a mobile telephone is of small volume, for example, of approximately 4 inches by 2 inches by 1 inch, or smaller, and the filtennas readily fit within such small volume.

In FIG. 25, the antenna 3_{5R} is typically a compressed antenna that lies in an XYZ-volume typically having magnetic current in the Z-axis direction normal to the XY-plane of the drawing. Such antennas operate in allocated frequency spectrums around the world including those of North America, South America, Europe, Asia and Australia. The cellular frequencies are used when the communication device 1 is a mobile phone, PDA, portable computer, telemetering equipment or any other wireless device. The antennas operate to transmit and/or receive in allocated frequency bands, for example, anywhere from 800 MHz to 2500 MHz.

In FIG. 26, the communication device 1 of FIG. 5 is shown in a schematic, cross-sectional, end view taken along the section line 6′-6″ of FIG. 5. In FIG. 6, a circuit board 6 includes, by way of example, an outer conducting layer 6-1₁, internal conducting layers 6-1₂ and 6-1₃, internal insulating layers 6-2₁, 6-2₂ and 6-2₃, and another outer conducting layer 6-1₄. In one example the layer 6-1₁ is a ground plane and the layer 6-1₂ is a power supply plane. The printed circuit board 6 supports the electronic components associated with the communication device 1 including a display 7 and miscellaneous components 8-1, 8-2, 8-3 and 8-4 which are shown as typical. Communication device 1 also includes a battery 9. The antennas 3_{5R} and 3_{5T} are mounted or otherwise coupled to the printed circuit board 6 by solder or other convenient connection means.

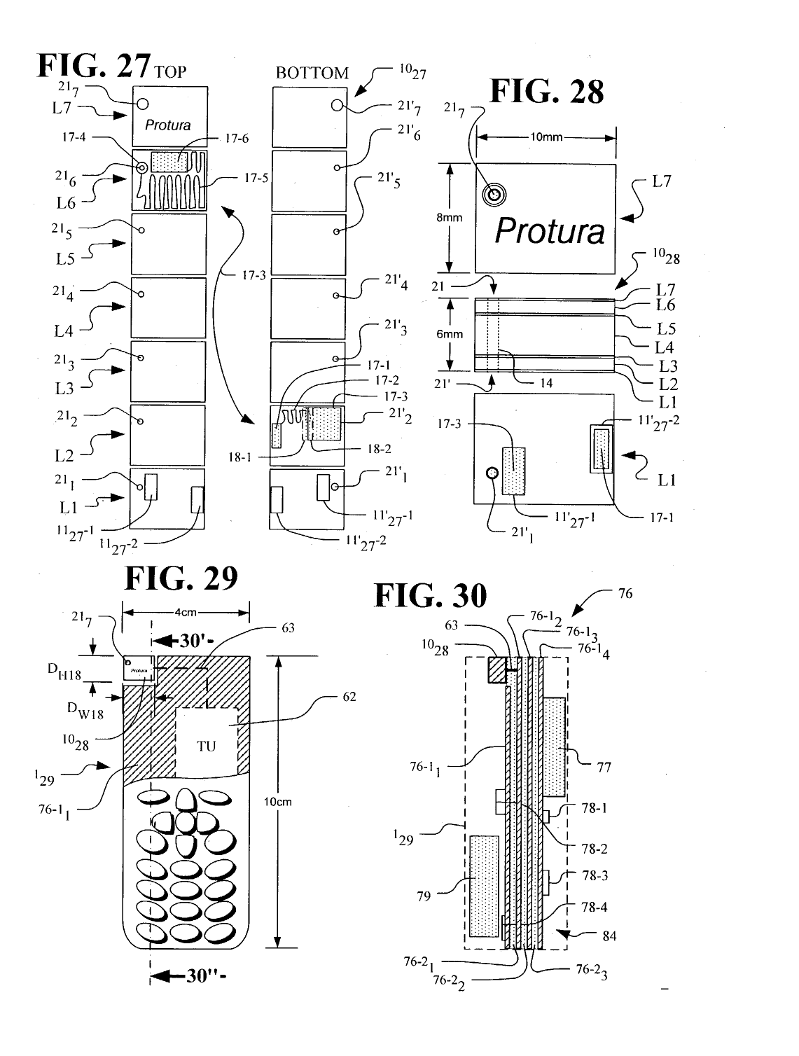

FIG. 27 depicts a top view and bottom view of unstacked layers L1, L2, . . . , L7, lying in a base plane (the plane of the drawing), for an antenna 10₂₇. In FIG. 27, each of the layers L1, L2, . . . , L7 has a TOP portion (top view) and a BOTTOM portion (bottom view).

All of the layers L1, L2, . . . , L7 have openings 21 on the TOP side including openings 21₁, 21₂, . . . , 21₇ connecting through to openings 21′ on the BOTTOM side including openings 21′₁, 21′₂, . . . , 21′₇. All of the openings 21₁, 21₂, . . . , 21₇ and openings 21′₁, 21′₂, . . . , 21′₇ are positioned so that they can be aligned in the finally assembled antenna (see FIG. 28) to provide a co-linear, through-layer connection from the layer L1 through each of the intermediate layers L2, . . . , L6 to layer L7. The finally assembled antenna (see FIG. 28) has layer L7 over layer L6 over layer L5 over layer L4 over layer L3 over layer L2 over layer L1 with all layers adhered together with all of the openings 21₁, 21₂, . . . , 21₇ and openings 21′₁, 21′₂, . . . , 21′₇ axially aligned. Typically, the openings 21 and 21′ are 0.64 mm in diameter.

The layer L1 of antenna 10₂₇ is a mask layer with openings 11₂₇-1, 11₂₇-2 and 21₁ on the TOP and corresponding openings 11′₂₇-1, 11′₂₇-2 and 21′₁ on the BOTTOM. The openings 11₂₇-2 and 11′₂₇-2 are aligned in the finally assembled antenna (see FIG. 28) and enable external contact to one end of the radiation element. The openings 11₂₇-1 and 11′₂₇-1 are aligned when assembled (see FIG. 28) to provide access to patch 17-3 to facilitate physically attaching the antenna 10₂₇ at a second point to a circuit board (see FIG. 30).

The layer L2 includes, on the TOP, the opening 21₂ and includes, on the BOTTOM, the opening 21′₂ and a section of the radiation element 17 including connection pad 17-1, a trace 17-2 and a patch 17-3. The trace 17-2 is formed of conducting segments that turn back and forth in many directions to establish an electrical length while compressing the area and volume of the antenna. The trace 17-2 can be regular or irregular in shape and is typically formed on a substrate using conventional printed circuit technology. The connection pad 17-1, trace 17-2 and patch 17-3 are electrically connected to each other and are electrically connected by a through-layer connection through opening 21′₂.

The layers L3, L4 and L5 include, on the TOP, the openings 21₃, 21₄ and 21₅ and include, on the BOTTOM, the openings 21′₃, 21′₄ and 21′₅. These openings provide for a through-layer connection 14 in the finally assembled antenna (see FIG. 28) from the patch 17-3 of layer L2 to connection pad 17-4 on layer L6. The layers L3 and L5 are pregnated separators. When the uncompressed antenna 10₂₇ of FIG. 27 is compressed into the final antenna 10₂₈ of FIG. 28, all the layers L1, L2, . . . , L7 are adhered together by the layers L3 and L5.

The layer L6 includes, on the TOP, the opening 21₆ and a section of the radiation element 17 including connection pad 17-4, trace 17-5 and patch 17-6 and includes on the BOTTOM, the opening 21′₆. The connection pad 17-4, trace 17-5 and patch 17-6 are electrically connected to each other and are electrically connected by the through-layer connection 14 (see FIG. 28) through opening 21₆ and opening 21′₆ through layers L5, L4 and L3 to the section of the radiation element on Layer L2 including patch 17-3, trace 17-2 and connection pad 17-1.

The layer L7 is a silk screen layer holding identifying data such as a logo “Protura” and other information that may be desired.

The radiation element 17 includes the series connection of connection pad 17-1, the trace 17-2, the patch 17-3, through-layer connection 14, connection pad 17-4, trace 17-5 and patch 17-6. The length, width, thickness, position and other attributes of all of the components of radiation element 17 combine to establish the electrical and radiation properties of element 17.

In FIG. 27, the patch 17-3 on layer L2 is adjusted in size to tune the high band (GSM1800, GSM1900) and the patch 17-6 on layer L6 is adjusted in size to tune the low band (GSM900). For example, if patch 17-3 is widened as shown at 18-1, more of the trace 17-2 is covered or if patch 17-3 is shortened as shown at 18-2, less of the trace 17-2 is covered. Such small adjustments in size are effective to make small adjustments in the antenna parameters, particularly the frequency band.

In FIG. 28, all of the layers L1, L2, . . . , L7 of FIG. 27 are shown finally assembled with all layers adhered together to form compressed antenna 10₂₈ in a volume. The compressed antenna 10₂₈ has approximate dimensions that are a width of 8 mm, a length of 10 mm and a height of 6 mm. The layers are superimposed with L7 over layer L6 over layer L5 over layer L4 over layer L3 over layer L2 over layer L1 with the openings 21 on the TOP side and the openings 21′ on the BOTTOM side coaxially aligned to provide the through-layer connection 14 from the layer L1 through each of the intermediate layers L2, . . . , L6 to layer L7. Through-layer connection 14 is established using standard circuit board processing steps. The processing steps include, in one example, assembling the compressed together with openings 21 and 21′ coaxially aligned. Sputtering is then performed to seed the openings with a conductive path. Finally, the through-layer connection 14 is completed by electroplating or other conventional circuit board technology.

In FIG. 28, the layer L1 is shown in the bottom view of antenna 10₂₈, with the openings 11′₂₇-1, 11′₂₇-2 and 21′₁. These openings expose in FIG. 28 the connection pad 17-1 and a portion of the patch 17-3, both being on the BOTTOM of layer L2. Solder or other connections are made between the connection pad 17-1 and patch 17-3 to a circuit board in a communication device (see FIG. 30). These connections function to connect the antenna 10₂₈ to a circuit board both electrically and mechanically.

In FIG. 29, a communication device 1₂₉ is shown partially cut-away and representing a cell phone, pager or other similar communication device that can be used in close proximity to people. The communication device 129 includes an antenna area allocated for antenna 10₂₈ of FIG. 28 which is offset from the ground plane 76-1₁. The antenna 10₂₈ receives and transmits radio wave radiation for the communication device 1₂₉. In FIG. 29, the antenna area is slightly larger than the width D_{W29} and length D_{L29} of antenna 10₂₈. In one embodiment, the antenna 10₂₈ has a clearance from the ground plane of approximately 1 mm on the right and 3 mm on the bottom with no ground plane on the top and left. A section line 30′-30″ extends from top to bottom of the communication device 1₂₉.

In FIG. 29, the compressed antenna 10₂₈ operates in allocated frequency spectrums around the world including those of North America, South America, Europe, Asia and Australia. The cellular frequencies are used when the communication device 1₂₉ is a mobile phone, PDA, portable computer, telemetering equipment or any other wireless device. The antenna 10₂₈ operates to transmit and/or receive as a tri-band device in frequency bands GSM900, GSM1800 and GSM1900. In other embodiments, compressed antennas operate to transmit and/or receive in allocated frequency bands, for example, anywhere from 800 MHz to 2500 MHz.

In FIG. 30, the communication device 1₂₉ of FIG. 29 is shown in a schematic, cross-sectional, end view taken along the section line 30′-30″ of FIG. 29. In FIG. 30, a circuit board 76 includes, by way of example, an outer conducting layer 76-1₁, internal conducting layers 76-1₂ and 76-1₃, internal insulating layers 76-2₁, 76-2₂ and 76-2₃, and another outer conducting layer 76-1₄. In one example, the layer 76-1₁ is a ground plane. The printed circuit board 76 supports the electronic components associated with the communication device 1₂₉ including a display 77 and miscellaneous components 78-1, 78-2, 78-3 and 78-4 which are shown as representative of many components. Communication device 1₂₉ also includes a battery 79. The antenna 10₂₈ is mounted or otherwise coupled to the multi-layered printed circuit board 76 by solder or other convenient connection means and has, for example, a connection 63 from the antenna 10₂₈ to components (such as 78-1, 78-2, 78-3 and 78-4 )that form the transceiver unit 62 of FIG. 29.

While the invention has been particularly shown and described with reference to preferred embodiments thereof it will be understood by those skilled in the art that various changes in form and details may be made therein without departing from the scope of the invention.

1. (Original) An antenna, for use with a communication device operating for exchanging energy in one or more bands of radiation frequencies, comprising,
one or more radiation elements, each element for operating in said bands and a first one of said elements including,
a plurality of electrically conducting segments connected to exchange energy in one or more of said bands of radiation frequencies,
said segments arrayed in a compressed pattern,
said compressed pattern extending in three dimensions to fill a cube.

2. (Original) The antenna of claim 1 wherein said radiation elements are deployed on a flexible substrate and said elements and said substrate are folded to fit within said cube.

3. (Original) The antenna of claim 1 wherein said first one of said radiation elements is deployed in regions having sections of the radiation element and is deployed on a flexible substrate where said first one of said radiation elements and said substrate are folded to fit within said cube and where said sections are separated by dielectric spacers.

4. (Original) The antenna of claim 1 wherein said first one of said elements is arrayed to form a loop.

5. (Original) The antenna of claim 1 wherein said first one of said elements includes one or more connection pads for electrical connection to RF components of said communication device.

6. (Original) The antenna of claim 5 wherein said connection pads are deposited on a common substrate said first one of said elements.

7. (Original) The antenna of claim 1 wherein said radiation elements terminate in one or more connection pads for surface mounting to a circuit board of said communication device.

8. (Original) The antenna of claim 1 wherein said bands include a US PCS band operating from 1850 MHz to 1990 MHz, a European DCS band operating from 1710 MHz to 1880 MHz, a European GSM band operating from 880 MHz to 960 MHz and a US cellular band operating from 829 MHz to 896 MHz.

9. (Original) The antenna of claim 1 wherein said elements are deployed on a single planar substrate folded to fit within said cube.

10. (Original) The antenna of claim 1 wherein said elements are formed by sections with different sections on different dielectric substrate layers where the sections of elements are electrically connected by through-layer connections connecting through the substrate layers.

11. (Original) The antenna of claim 1 wherein said elements are formed by sections deployed on the top and bottom sides of a common substrate.

12. (Original) The antenna of claim 11 where one of said sections is a closed loop and another of said sections is a compressed stub.

13. (Original) The antenna of claim 11 where said sections do not electrically connect.

14. (Original) The antenna of claim 1 wherein said segments are arrayed in multiple divergent directions not parallel to an orthogonal coordinate system so as to provide a long antenna electrical length while permitting the overall outside dimensions of said antenna to fit within said cube.

15. (Original) The antenna of claim 1 wherein said elements include contact areas for coupling to a transceiver of said communication device.

16. (Original) The antenna of claim 1 wherein said radiation element has an irregular shape and wherein said segments are arrayed in an irregular three-dimensional compressed pattern.

17. (Original) The antenna of claim 1 wherein said radiation elements transmit and receive radiation.

18. (Original) The antenna of claim 1 wherein said radiation elements transmit and receive in the GSM1900 band.

19. (Original) The antenna of claim 1 wherein said radiation elements transmit and receive in GSM1800 band.

20. (Original) The antenna of claim 1 wherein said radiation elements transmit and receive in a GSM900.

21. (Original) The antenna of claim 1 wherein said radiation elements transmit and receive in a US Cell band.

22. (Original) The antenna of claim 1 wherein said radiation elements transmit and receive in mobile telephone frequency bands anywhere from 800 MHz to 2500 MHz.

23. (Original) The antenna of claim 1 wherein a first one of said radiation elements is on one layer mounted on a dielectric material and where a conductive region is on a different layer mounted on said dielectric material juxtaposed said first one of said radiation loops.

24. (Original) The antenna of claim 1 wherein said radiation elements provide multi-band performance.

25. (Original) The antenna of claim 1 formed of multiple layers and includes a patch on one layer juxtaposed an area of one of said radiation elements on another layer to tune the antenna.

26. (Original) The antenna of claim 1 where said elements are arrayed to create a dual-band, band-pass antenna with good rejection between bands.

27. (Original) The antenna of claim 1 where said radiation elements are arrayed to create a tri-band, band-pass antenna with good rejection between bands.

28. (Original) The antenna of claim 1 where said radiation elements are arrayed to a create multi-band, band-pass antenna with good rejection between bands.

29. (Original) The antenna of claim 1 wherein said first one of said elements is deployed in sections on different layers of dielectric material and where said layers are superimposed with through-layer connections to electrically connect said sections.

30. (Original) The antenna of claim 29 wherein each of said layers of dielectric material have a an opening and where said layers are superimposed with said openings in alignment and where a through-layer connection connects through said openings to electrically connect said sections.

31. (Original) The antenna of claim 29 wherein said sections include connection pads, traces and patches electrically connected.

32. (Original) The antenna of claim 31 wherein said patches overlay portions of said traces to tune a frequency band of the antenna.

33. (Original) The antenna of claim 29 wherein a first one of said sections includes a first connection pad, a first trace and a first patch electrically connected wherein said first patch overlays a portion of said first trace to tune a first frequency band of the antenna and wherein a second one of said sections includes a second connection pad, a second trace and a second patch electrically connected wherein said second patch overlays a portion of said second trace to tune a second frequency band of the antenna.

34. (Original) The antenna of claim 33 wherein said antenna is a tri-band device.

35. (Original) The antenna of claim 34 wherein said bands include GSM900, GSM 1800 and GSM 1900.

36. (Original) The antenna of claim 35 wherein said first patch is for tuning said GSM900 band and wherein said second patch is for tuning said GSM4800 band and said GSM1900 band.

37. (Original) The antenna of claim 29 wherein said antenna has a bottom layer that exposes one or more connection pads for surface mounting to a circuit board of said communication device.

38. (Original) The antenna of claim 30 wherein said circuit board includes a ground plane and said antenna bottom <layer is offset from said ground plane by a clearance distance.

39. (Original) The antenna of claim 29 wherein said antenna has a bottom layer that exposes one connection pad for surface mounting to a circuit board at a first location and for electrical connection to a transceiver unit of said communication device.

40. (Original) The antenna of claim 38 wherein said bottom layer exposes a connection pad for surface mounting to said circuit board at a second location whereby said antenna is mechanically connected to the circuit board at two locations.

41. (Original) The antenna of claim 29 wherein said radiation elements provide multi-band performance.

42. (Original) The antenna of claim 41 wherein said performance includes GSM900, GSM 1800 and GSM 1900 bands.

43. (Original) An antenna, for use with a communication device operating for exchanging energy in one or more bands of radiation frequencies, comprising,
a radiation element including,
a plurality of electrically conducting segments connected to exchange energy in one or more of said bands of radiation frequencies,
said segments arrayed in a compressed pattern extending in three dimensions to fill a cube,
said radiation element deployed in sections on different layers of dielectric material, each of said layers of dielectric material having an opening, where said layers are superimposed to align said openings coaxially and where a through-layer connection connects through said openings to electrically connect said sections.

44. (Original) The antenna of claim 43 wherein said sections include connection pads, traces and patches electrically connected.

45. (Original) The antenna of claim 44 wherein said patches overlay portions of said traces to tune a frequency band of the antenna.

46. (Original) The antenna of claim 43 wherein a first one of said sections includes a first connection pad, a first trace and a first patch electrically connected wherein said first patch overlays a portion of said first trace to tune a first frequency band of the antenna and wherein a second one of said sections includes a second connection pad, a second trace and a second patch electrically connected wherein said second patch overlays a portion of said second trace to tune a second frequency band of the antenna.

47. (Original) The antenna of claim 46 wherein said antenna is a tri-band device.

48. (Original) The antenna of claim 47 wherein said bands include GSM900, GSM 1800 and GSM 1900.

49. (Original) The antenna of claim 46 wherein said first patch is for tuning said GSM900 band and wherein said second patch is for tuning said GSM1800 band and said GSM1900 band.
